(19) United States
(12) Patent Application Publication
(10) Pub. No.: US 2023/0407026 A1
(43) Pub. Date: Dec. 21, 2023

(54) PROTECTING FILM FOR COVER WINDOW OF FLEXIBLE DISPLAY DEVICE, COVER WINDOW AND FLEXIBLE DISPLAY DEVICE COMPRISING THE SAME

(71) Applicant: LG CHEM, LTD., Seoul (KR)

(72) Inventors: Hanna LEE, Daejeon (KR); Inkyu LEE, Daejeon (KR); Yeongrae CHANG, Daejeon (KR); Jin Young PARK, Daejeon (KR); Yongjoon HEO, Daejeon (KR)

(73) Assignee: LG CHEM, LTD., Seoul (KR)

(21) Appl. No.: 18/255,733

(22) PCT Filed: Jan. 15, 2021
(86) PCT No.: PCT/KR2021/000625

§ 371 Date: Jun. 2, 2023

(51) Int. Cl. C08J 7/04; B32B 27/36; B32B 17/10; B32B 27/08; C09D 135/02; C09D 7/61

(52) U.S. Cl. CPC C08J 7/042; B32B 27/36; B32B 17/10; B32B 27/08; C09D 135/02; C09D 7/61; B32B 2307/7376; B32B 2255/28; B32B 2457/20; B32B 2255/26; B32B 2307/536; B32B 2307/546; B32B 2307/584; B32B 2307/414; B32B 2255/10; C08J 2435/02; C08J 2367/02

(57) ABSTRACT

The present disclosure relates to a protecting film for a cover window of a flexible display device in which a first hard coating layer containing 3 parts by weight or less of inorganic particles based on 100 parts by weight of a binder resin; a second hard coating layer containing 10 to 45 parts by weight of inorganic particles based on 100 parts by weight of a binder resin; and a light-transmitting substrate are sequentially laminated, wherein the first hard coating layer and the second hard coating layer have a specific thickness ratio, a cover window and a display device including the same.

### CROSS-REFERENCE TO RELATED APPLICATION(S)

This application is a 35 U.S.C. 371 National Phase Entry Application from PCT/KR2021/000625, filed Jan. 15, 2021, the entire contents of which are incorporated herein by reference.

### FIELD OF THE INVENTION

The present disclosure relates to a protecting film for a cover window of a flexible display device, a cover window and a display device including the same.

### BACKGROUND OF THE INVENTION

Recently, the demand for display devices that input, manipulate, and display information through a touch screen such as a television, a computer, a mobile communication device, a smart phone, a vehicle navigation system, and an automated teller machine is increasing. In order to apply them to a wider variety of uses, not only flat displays, but also flexible displays that can be bent or folded have recently been released.

A cover window for such a flexible display is a layer applied to the outermost side of the flexible display, and requires excellent flexibility in order to exhibit high hardness and scratch resistance while satisfying bendable, foldable, and rollable characteristics. In general, in order to satisfy the high hardness, glass is used as a cover panel.

However, when the glass is used as a cover panel, the hardness is excellent, but impact resistance is lowered, so that it is fragile when an impact occurs and fragments are generated, which is dangerous for the user to handle. Thus, there is a need for a protecting film on the cover panel capable of preventing scattering of glass and improving impact resistance.

However, the existing protecting film having excellent scratch resistance and hardness has a problem in that bending resistance is lowered and thus dynamic folding and static folding are deteriorated, and the existing protecting film having excellent bending resistance has a problem in that scratch resistance and hardness are deteriorated. Accordingly, there is a need for a protecting film having excellent scratch resistance and hardness with excellent bending resistance.

### SUMMARY OF THE INVENTION

### Technical Problem

There is provided a protecting film for a cover window of a flexible display device simultaneously satisfying a balance of physical properties of flexibility, high hardness and scratch resistance, and having little damage even by repetitive bending or folding operations. The protecting film can improve impact resistance of a glass panel and prevent scattering when the glass panel is broken.

In addition, there is provided a cover window of a flexible display device including the above protecting film, which exhibits flexibility, bending resistance, high hardness scratch resistance, and high transparency. In particular, there is almost little damage even by repetitive bending or folding operations, so the cover window can be easily applied to a bendable, flexible, rollable, or foldable mobile device, or a display device.

There is also provided a flexible display device including the above cover window.

### Technical Solution

In the present disclosure, there is provided a protecting film for a cover window of a flexible display device in which a first hard coating layer containing 3 parts by weight or less of inorganic particles based on 100 parts by weight of a binder resin; a second hard coating layer containing 10 to 45 parts by weight of inorganic particles based on 100 parts by weight of a binder resin; and a light-transmitting substrate are sequentially laminated, wherein a thickness ratio of the first hard coating layer and the second hard coating layer is 10:90 to 40:60.

In the present disclosure, there is also provided a cover window of a flexible display device including the above protecting film for a cover window of a flexible display device.

In addition, there is also provided a flexible display device including the cover window of a flexible display device.

### DETAILED DESCRIPTION OF THE INVENTION

Hereinafter, the protecting film for a cover window of a flexible display device, the cover window of a flexible display device including the same, and the flexible display device including the same will be described in more detail.

In the present disclosure, “flexible” means a state having flexibility in which no cracks of 3 mm or more in length occur when wound around a cylindrical mandrel having a diameter of 8 mm or less, and therefore, the flexible plastic film of the present disclosure can be applied as a cover film of a bendable, flexible, rollable, or foldable display.

In the present disclosure, “(meth)acrylate” includes both acrylate and methacrylate.

In the present disclosure, the “light-transmitting substrate” refers to a substrate having a transmittance of 50% or more in a visible light region, for example, in the range of 380 to 780 nm.

In the present disclosure, the weight average molecular weight refers to a weight average molecular weight converted with polystyrene measured by gel permeation chromatography (GPC). In the process of measuring the weight average molecular weight converted with polystyrene measured by the GPC method, a commonly known analyzer, a detector such as a refractive index detector and a column for analysis may be used, and generally applied temperature conditions, solvents, and flow rates may be applied. For example, the measurement may be performed using Waters PL-GPC220 and a Polymer Laboratories PLgel MIX-B 300 mm length column. An evaluation temperature is 160° C., and 1,2,4-trichlorobenzene is used for a solvent at a flow rate of 1 mL/min. The sample at a concentration of 10 mg/10 mL is supplied in an amount of 200 μL. Mw can be obtained using a calibration curve formed using a polystyrene standard. 9 kinds of the polystyrene standard are used with the molecular weight 2,000/10,000/30,000/70,000/200,000/700,000/2,000,000/4,000,000/10,000,000.

According to an embodiment of the present disclosure, there may be a protecting film for a cover window of a flexible display device in which a first hard coating layer containing 3 parts by weight or less of inorganic particles based on 100 parts by weight of a binder resin; a second hard coating layer containing 10 to 45 parts by weight of inorganic particles based on 100 parts by weight of a binder resin; and a light-transmitting substrate are sequentially laminated, wherein a thickness ratio of the first hard coating layer and the second hard coating layer is 10:90 to 40:60.

The present inventors conducted a study on an optical laminate applicable to a protecting film for a cover window of a flexible display device, and they have found that when a lower hard coating layer (hereinafter, referred to as a second hard coating layer) in contact with the light-transmitting substrate is thicker than an upper hard coating layer (hereinafter, referred to as a first hard coating layer), for example, a thickness ratio of the first hard coating layer and the second hard coating layer is 10:90 to 40:60, and the first and second hard coating layers contain inorganic particles in a specific amount in an optical laminate having a two-layered hard coating layer on one surface of a light-transmitting substrate, cracks do not occur when wound around a mandrel having a diameter of 8 mm or less while having high hardness and excellent scratch resistance. Therefore, it can be used as a protecting film for a cover window of a flexible display device, and the invention was completed.

In addition, it has been confirmed through experiments that the protecting film for a cover window of a flexible display device simultaneously satisfies the balance of flexibility and high hardness while exhibiting excellent scratch resistance and high hardness. In particular, there is almost no damage to the film even by repetitive bending or folding operations, so the film could be easily applied to a bendable, flexible, rollable, or foldable mobile device, or a display device, thereby completing the invention.

As described above, physical properties such as bending durability, scratch resistance, and high hardness of the protecting film for a cover window of a flexible display device may be related to components included in the first hard coating layer and the second hard coating layer, in particular, related to components of the binder resin, the presence or absence of inorganic particles in the binder resin, and the content thereof. Alternatively, the above-described physical properties may also be related to the thickness ratio of the first hard coating layer and the second hard coating layer.

A two-layered hard coating layer may be formed on the light-transmitting substrate included in the protecting film for a cover window of a flexible display device, and as described above, the protecting film may sequentially include a first hard coating layer, a second hard coating layer, and a substrate by forming the second hard coating layer on the light-transmitting substrate, and then forming the first hard coating layer on the second hard coating layer. As the protecting film includes the light-transmitting substrate and the two-layered hard coating layer, excellent bending resistance, hardness, and scratch resistance may be simultaneously achieved. In addition, with this structure, the balance of flexibility, scratch resistance, and high hardness can be satisfied at the same time, damage to the internal structure by repetitive bending or folding operations can be prevented, and optical properties such as high transparency along with excellent mechanical properties and heat resistance can be obtained.

In the above-described two-layered hard coating layer, the second hard coating layer, which is a lower layer, contains 100 parts by weight of a binder resin and 10 to 45 parts by weight, 10 to 40 parts by weight, 15 to 35 parts by weight, or 20 to 30 parts by weight of inorganic particles based on 100 parts by weight of the binder resin. Meanwhile, the first hard coating layer, which is an upper layer, may contain 100 parts by weight of a binder resin and 3 parts by weight or less, 1 parts by weight or less, or 0.1 parts by weight or less of inorganic particles based on 100 parts by weight of the binder resin, or may not contain inorganic particles.

The inorganic particles may function to improve hardness of the hard coating layer, but when inorganic particles are present on the surface of the hard coating layer due to weak interaction with the binder resin, scratch resistance may be deteriorated due to surface roughness.

Therefore, in order to improve scratch resistance of the protecting film for a cover window of a flexible display device according to the embodiment, the first hard coating layer, which is an upper layer, may contain 3 parts by weight or less, 1 parts by weight or less, or 0.1 parts by weight or less of inorganic particles based on 100 parts by weight of the binder resin, or may not contain inorganic particles. If the first hard coating layer contains more than 3 parts by weight of inorganic particles based on 100 parts by weight of the binder resin, the scratch resistance of the protecting film is deteriorated, so that scratches may easily occur by external impact.

On the other hand, in order to improve hardness of the protecting film for a cover window of a flexible display device, the second hard coating layer, which is a lower layer, may contain 10 to 45 parts by weight, 10 to 40 parts by weight, 15 to 35 parts by weight, or 20 to 30 parts by weight of inorganic particles based on 100 parts by weight of the binder resin. For this reason, the balance of physical properties of flexibility and high hardness can be satisfied at the same time, damage to the internal structure by repetitive bending or folding operations can be prevented, and optical properties such as high transparency along with excellent mechanical properties and heat resistance can be obtained.

If too little inorganic particles are contained in the second hard coating layer, sufficient hardness cannot be achieved, and if too many inorganic particles are contained, the coating layer becomes brittle, resulting in a problem of low bending properties.

The inorganic particles may be at least one selected from the group consisting of metal oxide particles such as silica, aluminum oxide, zirconia, titania, zinc oxide, germanium oxide, indium oxide, tin oxide, indium tin oxide, antimony oxide, cerium oxide, and the like; metal fluoride particles such as magnesium fluoride, sodium fluoride, and the like; metal sulfide particles; metal nitride particles; and metal particles.

In addition, the diameter of the inorganic particles may be 1 to 300 nm, 10 to 200 nm, or 30 to 100 nm.

In the protecting film for a cover window of a flexible display device according to the embodiment, the balance of physical properties of flexibility, high hardness, and scratch resistance can be satisfied at the same time, damage to the internal structure by repetitive bending or folding operations can be prevented, and optical properties such as high transparency along with excellent mechanical properties and heat resistance can be obtained. In addition, such a balance of physical properties and excellent optical properties may be related to the thickness of the first hard coating layer and the second hard coating layer.

In the above-described two-layered hard coating layer, the first hard coating layer, which is an upper layer, may be thinner than the second hard coating layer, which is a lower layer. Specifically, the thickness ratio of the first hard coating layer and the second hard coating layer may be 10:90 to 40:60, 15:85 to 35:65, or 20:80 to 30:70. If the thickness ratio of the first hard coating layer and the second hard coating layer is less than 10:90, scratch resistance may be deteriorated, and if it exceeds 40:60, bending properties may be deteriorated.

Meanwhile, the thickness of the first hard coating layer may be 1 μm to 10 μm, 1 μm to 9 μm, or 2 μm to 7 μm. If the thickness of the first hard coating layer is too thick, bending properties may be deteriorated, and if it is too thin, scratch resistance may be deteriorated.

The thickness of the second hard coating layer may be 1 μm to 10 μm, 2 μm to 9 μm, or 3 μm to 8 μm. If the thickness of the second hard coating layer is too thick, bending properties may be deteriorated, and if it is too thin, hardness may be deteriorated Meanwhile, the total thicknesses of the first hard coating layer and second hard coating layer may be 2 μm to 17 μm, 3 μm to 16 μm, or 4 μm to 15 μm.

In the case of including a structure in which a first hard coating layer and a second hard coating layer having the above-described components and characteristics are sequentially laminated, the protecting film has superior scratch resistance, flexibility, and elasticity compared to the case of including a hard coating layer having the same thickness while achieving a high level of hardness, and further, there is less occurrence of curl, so that curl property may be excellent.

If the total thicknesses of the first hard coating layer and the second hard coating layer is excessively thick, crack resistance and durability against repetitive bending or folding operations may be deteriorated. On the other hand, if the total thickness becomes excessively thin, the hardness is lowered, and thus scratches may occur by external impact.

Meanwhile, since the protecting film for a cover window of a flexible display device described above has the specific composition and structure, durability against repetitive bending or folding operations applied to the protecting film is also excellent.

Specifically, cracks may not occur when both sides of the protecting film are folded and unfolded at 90 degrees with respect to a bottom surface 100,000 times at room temperature with a 4 mm gap in the middle of the protecting film for a cover window of a flexible display device. Repeating folding and unfolding with a 4 mm gap in the middle of the protecting film may be, for example, a bending test performed on the protecting film with a rod having a diameter of 4 mm.

FIG. 1 schematically shows a method for evaluating dynamic bending properties.

Referring to FIG. 1, durability against bending may be measured by placing the protecting film horizontally on the ground, and repeating folding and unfolding at 90 degrees with respect to a bottom surface 100,000 times at a rate of once per 1.5 seconds at 25° C. such that a gap between folded parts in the middle of the protecting film is 4 mm. At this time, in order to keep the gap between the folded parts constant, it may be measured, for example, by placing a rod having a diameter (R) of 4 mm in contact with the protecting film, fixing the rest of the protecting film, and repeating folding and unfolding both sides of the protecting film around the rod. In addition, the folded part is not particularly limited as long as it is inside the protecting film, and for convenience of measurement, the central part of the protecting film may be folded such that both sides of the protecting film are symmetrical except for the folded part.

In this dynamic bending evaluation, cracks of 1 cm or more, or 3 mm or more do not occur in the protecting film even after bending 100,000 times, and cracks may not occur substantially. In particular, cracks do not occur even when the protecting film is bent either inwards or outwards, and for example, cracks do not occur even when the light-transmitting substrate of the protecting film is folded inwards or the first hard coating layer is folded inwards. Therefore, it can be suitably applied as a protecting film for a cover window of a flexible display device, because the possibility of cracking even in an actual use such as repetitive folding, rolling, or bending is very low.

In addition, the protecting film for a cover window of a flexible display device may have a pencil hardness of H or more, when measured on a surface of the first hard coating layer under a load of 750 g.

In addition, the protecting film for a cover window of a flexible display device may have a water contact angle of 105° or more on the surface of the first hard coating layer. When the protecting film is used for a display faceplate in a touch panel, the first hard coating layer may function as a touch surface. Since the protecting film has a water contact angle of 105° or more, the touch panel can be freely operated by sliding a finger or pen on the touch surface.

Meanwhile, the protecting film for a cover window of a flexible display device of the embodiment may have a transmittance with respect to light having a wavelength of 550 nm of 90.0% or more, 92.0% or more, or 94.0% or more, and a haze of 1.0% or less, 0.7% or less, or 0.5% or less.

The protecting film for a cover window of a flexible display device of the embodiment includes the hard coating layer having high hardness and capable of securing durability against repetitive bending or folding operations, and these characteristics of the hard coating layer may be related to the composition of the binder resin included in the hard coating layer, the presence or absence of inorganic particles, and the content thereof.

Specifically, the binder resin included in the first hard coating layer and the second hard coating layer may each independently include a multifunctional (meth)acrylate-based compound. The multifunctional (meth)acrylate-based compound may be, for example, a multifunctional (meth)acrylate-based monomer, a multifunctional (meth)acrylate-based oligomer, or a mixture thereof.

Specifically, the first hard coating layer and the second hard coating layer may contain the same multifunctional (meth)acrylate-based compound, or may contain different multifunctional (meth)acrylate-based compounds. At this time, as described above, the binder resin of the first hard coating layer may contain 3 parts by weight or less, 1 parts by weight or less, or 0.1 parts by weight or less of inorganic particles based on 100 parts by weight of the binder resin, or may not contain inorganic particles. The second hard coating layer may contain 10 to 45 parts by weight, 10 to 40 parts by weight, 15 to 35 parts by weight, or 20 to 30 parts by weight of inorganic particles based on 100 parts by weight of the binder resin.

Specifically, the multifunctional (meth)acrylate-based compound has 2 to 10 (meth)acrylate functional groups, and a weight average molecular weight of 50 to 2,000 g/mol, 10 to 1,000 g/mol, or 100 to 700 g/mol. In addition, an acrylate equivalent weight may be 50 to 1000 g/mol, 100 to 900 g/mol, or 150 to 800 g/mol.

In addition, the first hard coating layer and the second hard coating layer may each independently contain 50 parts by weight or more, 60 parts by weight to 100 parts by weight, or 70 parts by weight to 95 parts by weight of the multifunctional (meth)acrylate-based compound based on 100 parts by weight of the binder resin, thereby improving flexibility of the hard coating layer including the binder resin.

Further, the multifunctional (meth)acrylate-based compound may be modified with at least one selected from the group consisting of ethylene oxide, propylene oxide, urethane, caprolactone, epoxy and ester. Specifically, the multifunctional (meth)acrylate-based compound has excellent flexibility and can impart flexibility to a hard coating layer using the same. In addition, the above-described modified multifunctional (meth)acrylate-based oligomer has improved flexibility, and a hard coating layer using the same may have increased curl property and flexibility.

The multifunctional (meth)acrylate-based oligomer may have 2 to 10 acrylate functional groups, a weight average molecular weight of 200 to 2,000 g/mol, 300 to 1,000 g/mol, or 350 to 500 g/mol, and an acrylate equivalent weight of 100 to 1000 g/mol, 200 to 900 g/mol, or 300 to 800 g/mol. The (meth)acrylate-based oligomer is not limited thereto, but may include, for example, one or more functional groups selected from the group consisting of urethane, epoxy, ether, alkylene oxide, and ester.

Meanwhile, the multifunctional (meth)acrylate-based monomer may have 2 to 6 acrylate functional groups, and a weight average molecular weight of 50 to 600 g/mol, 50 to 500 g/mol, or 50 to 300 g/mol. In addition, the multifunctional (meth)acrylate-based monomer may have an acrylate equivalent weight of 50 to 300 g/mol, 70 to 250 g/mol, or 100 to 200 g/mol. The multifunctional (meth)acrylate-based monomer may be trimethylolpropane triacrylate (TMPTA), trimethylolpropaneethoxy triacrylate (TMPEOTA), glycerin propoxylated triacrylate (GPTA), pentaerythritol tetraacrylate (PETA), dipentaerythritol hexaacrylate (DPHA), or the like, but the present disclosure is not limited thereto.

The first hard coating layer may further contain at least one additive selected from the group consisting of a fluorine-based additive, a silicone-based additive, and a fluorine-silicone-based additive. The additive may facilitate finger sliding, and may enhance stain resistance and wipeability against stains. In the first hard coating layer, 0.5 to 5 parts by weight, 1 to 4 parts by weight, or 2 to 3 parts by weight of the additive may be contained based on 100 parts by weight of the binder resin. If the content of the additive is too small, finger sliding may become difficult, and stain resistance and wipeability against stains may be deteriorated, and if the content of the additive is too high, the content of other components is reduced, resulting in a decrease in strength and scratch resistance.

The fluorine-based additive may be fluoropolyether, fluoropolyalkyl, or a mixture thereof, but is not limited thereto. In addition, the silicone-based additive may be a silicone resin modified with various organic groups such as polyether, alkyl, acryl, and epoxy, but is not limited thereto.

In addition, the fluorine-silicone-based additive may be a polydialkylsiloxane-based polymer in which at least one silicone is substituted with one or more fluorine, for example, a siloxane-fluoropolyalkyl-based compound, but is not limited thereto.

Meanwhile, the protecting film for a cover window of a flexible display device preferably includes a light-transmitting substrate that simultaneously satisfies the balance of flexibility, high hardness, and high scratch resistance, and can prevent damage to the internal structure by repetitive bending or folding operations while having excellent optical properties in order to achieve the above-described characteristics. Herein, the light-transmitting substrate refers to a substrate having a transmittance of 50% or more in a visible light region, for example, in the range of 380 to 780 nm.

Specifically, a yellow index of the light-transmitting substrate measured in accordance with ASTM D1925 may be 4.5 or less, or 3.8 or less, and a haze of the light-transmitting substrate measured in accordance with ASTM D1003 may be 1.1% or less, or 0.4 to 0.8%, thereby having colorless and transparent optical properties.

The light-transmitting substrate is not particularly limited as long as it satisfies the above-described characteristics, but it may include, for example, at least one selected from the group consisting of polyimide (PI), polyimideamide, polyetherimide (PEI), polyethyleneterephtalate (PET), polyethylenenaphthalate (PEN), polyetheretherketon (PEEK), cyclic olefin polymer (COP), polyacrylate (PAC), polymethylmethacrylate (PMMA), and triacetylcellulose (TAC).

In addition, a thickness of the light-transmitting substrate may be 5 μm to 150 μm, 10 μm to 130 μm, or 20 μm to 100 μm. If the thickness of the light-transmitting substrate is too thin, breakage or curling may occur in the formation of the coating layer, and it may be difficult to achieve high hardness. On the other hand, if the thickness is too thick, flexibility may be low and it may be difficult to form a flexible film.

Meanwhile, the total thickness of the first hard coating layer, the second hard coating layer, and the light-transmitting substrate may be 40 μm to 150 μm, 50 μm to 140 μm, 60 μm to 130 μm, or 60 μm to 120 μm.

As described above, when including a structure in which a first hard coating layer and a second hard coating layer having the specific components and characteristics are sequentially laminated, the protecting film has excellent scratch resistance, flexibility, and elasticity compared to the case of including a hard coating layer having the same thickness while achieving a high level of hardness, and further, there is less occurrence of curl, so that curl property may be excellent. Accordingly, mechanical properties or elastic properties required for a protecting film for a cover window of a flexible display device can be achieved without significantly increasing the thickness of the light-transmitting substrate.

If the total thickness of the first hard coating layer, the second hard coating layer, and the light-transmitting substrate is excessively thick, crack resistance against repetitive bending or folding operations may be reduced or flexibility may be deteriorated. If the total thickness is excessively thin, hardness is lowered, and scratches or curls may occur by external impact.

Meanwhile, the protecting film for a cover window of a flexible display device may be provided by applying a coating composition for forming a second hard coating layer on at least one surface of the light-transmitting substrate, followed by photocuring to form a second hard coating layer, and then applying a coating composition for forming a first hard coating layer on the second hard coating layer, followed by photocuring.

The method of applying the coating composition is not particularly limited as long as it can be used in the art. For example, a bar coating method, a knife coating method, a roll coating method, a blade coating method, a die coating method, a micro gravure coating method, a comma coating method, a slot die coating method, a lip coating method, a solution casting method, and the like may be used.

Between the light-transmitting substrate and the second hard coating layer, between the first hard coating layer and the second hard coating layer, or on the first hard coating layer, one or more layers or films such as a plastic resin film, a pressure-sensitive adhesive film, a release film, a conductive film, a conductive layer, a liquid crystal layer, a coating layer, a cured resin layer, a non-conductive film, a metal mesh layer or a patterned metal layer may be further included.

For example, an antistatic layer may be first formed on the light-transmitting substrate, and then a second hard coating layer may be formed thereon to impart an anti-static function, or a low-refractive index layer may be formed on the first hard coating layer to impart a low reflection function.

In addition, the layer, film, or the like may be in any form of a single layer, a double layer, or a laminate-type. The layer, film, or the like may be laminated on the coating layer by lamination, coating, vapor deposition, sputtering, etc., of a freestanding film using an adhesive or a pressure-sensitive adhesive film, but the present disclosure is not limited thereto.

Meanwhile, the first and second hard coating layers may further contain a component commonly used in the art such as a photoinitiator, an organic solvent, a surfactant, a UV absorber, a UV stabilizer, an anti-yellowing agent, a leveling agent, an antifouling agent, or a dye for improving color in addition to the binder resin, inorganic fine particles, and the like. In addition, the content thereof may be variously adjusted within a range that does not degrade physical properties of the hard coating layer, so it is not particularly limited. For example, the component may be included in an amount of about 0.01 to about 30 parts by weight based on 100 parts by weight of the hard coating layer.

The surfactant may be a fluorine-based acrylate, a fluorine-based surfactant, or a silicone-based surfactant having the functionality of 1 to 2. In this case, the surfactant may be contained in a dispersed or cross-linked form in the hard coating layer.

In addition, the additive may include a UV absorber or a UV stabilizer. The UV absorber may include a benzophenone-based compound, a benzotriazole-based compound, or a triazine-based compound, and the UV stabilizer may include tetramethyl piperidine, or the like.

The photoinitiator may include 1-hydroxy-cyclohexyl-phenyl ketone, 2-hydroxy-2-methyl-1-phenyl-1-propanone, 2-hydroxy-1-[4-(2-hydroxyethoxy)phenyl]-2-methyl-1-propanone, methylbenzoylformate, α,α-dimethoxy-α-phenylacetophenone, 2-benzoyl-2-(dimethylamino)-1-[4-(4-morpholinyl)phenyl]-1-butanone, 2-methyl-1-[4-(methylthio)phenyl]-2-(4-morpholinyl)-1-propanone diphenyl(2,4,6-trimethylbenzoyl)-phosphine oxide, bis(2,4,6-trimethylbenzoyl)-phenylphosphine oxide, or the like, but the present disclosure is not limited thereto. In addition, commercially available products may include Irgacure 184, Irgacure 500, Irgacure 651, Irgacure 369, Irgacure 907, Darocur 1173, Darocur MBF, Irgacure 819, Darocur TPO, Irgacure 907, Esacure KIP 100F, and the like. These photoinitiators may be used alone or in combination of two or more thereof.

The organic solvent may include an alcohol-based solvent such as methanol, ethanol, isopropyl alcohol, and butanol, an alkoxy alcohol-based solvent such as 2-methoxyethanol, 2-ethoxyethanol, and 1-methoxy-2-propanol, a ketone-based solvent such as acetone, methyl ethyl ketone, methyl isobutyl ketone, methyl propyl ketone, and cyclohexanone, an ether-based solvent such as propylene glycol monopropyl ether, propylene glycol monomethyl ether, ethylene glycol monoethyl ether, ethylene glycol monopropyl ether, ethylene glycol monobutyl ether, diethylene glycol monomethyl ether, diethyl glycol monoethyl ether, diethyl glycol monopropyl ether, diethyl glycol monobutyl ether, and diethylene glycol-2-ethylhexyl ether, and an aromatic solvent such as benzene, toluene, and xylene. These may be used alone or in combination thereof.

Meanwhile, according to another embodiment of the present disclosure, there is provided a cover window of a flexible display device including the protecting film for a cover window of a flexible display device.

In addition, the cover window of a flexible display device may further include a glass cover or a plastic film cover formed on one surface of the protecting film for a cover window and having a thickness of 20 μm to 180 μm. That is, the cover window of a flexible display device includes a cover and a protecting film for a cover window formed on one surface of the cover, and the cover may be a glass cover or a plastic film cover.

The glass cover and the plastic film cover may be transparent, thereby allowing light from the display panel inside the flexible display device to pass therethrough.

In addition, the glass cover may have high hardness and excellent scratch resistance, but may be easily broken due to reduced impact resistance. The glass cover may include, for example, glass having a high refractive index (e.g., a refractive index of 1.65 or more), but is not limited thereto. However, since the cover window of a flexible display device according to another embodiment has the protecting film on the glass panel, impact resistance of the glass panel is improved, and scratches or dents caused by external impact can be prevented. It can also prevent scattering when the glass panel is broken, so that it is not dangerous for users to handle.

In addition, the plastic film cover may have high hardness and excellent scratch resistance, and may include at least one selected from the group consisting of a polyimide film, a polyimideamide film, a polyetherimide film, a polyethylene terephthalate film, a polyethylene naphthalate film, a polyether ether ketone film, a cyclic olefin polymer film, a polyacrylate film, a polymethyl methacrylate film, and a triacetyl cellulose film.

Each of the glass cover and the plastic film cover may have a thickness of 20 μm to 180 μm. If the thickness is too thin, there is a problem in that hardness characteristics are deteriorated, and if the thickness is too thick, there is a problem in that cracks occur in the dynamic bending test.

For example, the glass cover may have a thickness of 20 μm to 180 μm, 25 μm to 150 μm, 30 μm to 120 μm, or 30 μm to 100 μm.

In addition, the plastic film cover may have a thickness of 20 μm to 180 μm, 30 μm to 170 μm, 40 μm to 150 μm, or 50 μm to 130 μm.

The cover window of a flexible display device may further include a pressure-sensitive adhesive layer. The pressure-sensitive adhesive layer may be disposed between the cover and the protecting film. The pressure-sensitive adhesive layer may attach the cover and the protecting film by pressure (pressing force) at room temperature.

The pressure-sensitive adhesive layer may be formed with an adhesive or a pressure-sensitive adhesive film, and is not particularly limited as long as it is known in the art. Meanwhile, the pressure-sensitive adhesive film is not particularly limited as long as it is known in the art, but a double-sided pressure-sensitive adhesive film such as an optically clear adhesive (OCA) film may be used.

Meanwhile, according to another embodiment of the present disclosure, there is provided a display device including the cover window of a flexible display device.

The display device may be a flexible display device. For example, the flexible display device may include a touch panel of a curved, bendable, flexible, rollable or foldable-shaped mobile communication device, smart phone or tablet PC, a wearable device, and various displays. Examples of the wearable device include an accessory type (e.g., watch, ring, bracelet, anklet, necklace, glasses, contact lens or head-mounted-device (HMD)), a fabric or garment-integrated type (e.g., electronic garment), a body attaching type (e.g., skin pad or tattoo), or a bioimplant type (e.g., implantable circuit).

The flexible display device may include a display panel and a cover window. In addition, the cover window may include a cover and a protecting film, and may further include a pressure-sensitive adhesive layer between the cover and the protecting film.

The flexible display apparatus may be, for example, a liquid crystal display (LCD) device, a light emitting diode (LED) display device, an organic light emitting diode (OLED) display device, a micro electro mechanical system (MEMS) display device, or a rollable or foldable display device.

For example, the organic light emitting diode (OLED) display device may have a cover window of the flexible organic light emitting diode display device at an outer part in a direction in which light or a screen is emitted. And a cathode for providing electrons, an electron transport layer, an emission layer, a hole transport layer, and an anode for providing holes may be sequentially formed. In addition, the organic light emitting diode (OLED) display may further include a hole injection layer (HIL) and an electron injection layer (EIL).

In order for the organic light emitting diode (OLED) display to function and act as a flexible display, the electrodes of the cathode and the anode and each component may use an elastic material.

Another example of the flexible display device may be a rollable display or a foldable display.

The rollable display device may have various structures depending on application fields and specific forms, and may have a structure including a cover window, a touch panel, a polarizing plate, a barrier film, a light emitting device (OLED element, etc.), a transparent substrate, and the like.

### Advantageous Effects

According to the present disclosure, it is possible to provide a protecting film for a cover window of a flexible display device satisfying the balance of physical properties of flexibility, high hardness and scratch resistance and hardly damaged even by repetitive bending or folding operations. In addition, the protecting film improves impact resistance of a glass cover or a plastic film cover, and prevents scattering when the glass cover is broken.

In addition, a cover window and a flexible display device including the protecting film for a cover window of a flexible display device exhibit flexibility, bending resistance, high hardness, scratch resistance, and high transparency, and in particular, there is little damage to the film even by repetitive bending or folding operations. Accordingly, they may be usefully applied to a bendable, flexible, rollable, or foldable mobile device, a display device, a front panel or a display unit of various control panels, and the like.

### BRIEF DESCRIPTION OF THE DRAWINGS

FIG. 1 schematically shows a method of performing a bending durability test of Experimental Example 3.

### DETAILED DESCRIPTION OF THE EMBODIMENTS

Hereinafter, the function and effect of the present invention will be described in more detail with specific embodiments. However, these embodiments are merely presented as an example of the invention, and the scope of the invention is not defined thereby.

### Preparation Examples: Preparation of Coating Solution for Forming Hard Coating Layer

### Preparation Example 1-1

100 g of MF001 (manufacturer: Daiichi Kogyo Seiyaku, 5- to 6-functional, ethylene oxide-modified) as a multifunctional acrylate-based compound, 2 g of RS-537 (manufacturer: DIC) as a fluorine-based additive, 2 g of 1184 (manufacturer: Ciba) as a photoinitiator, and 100 g of methyl isobutyl ketone as a solvent were mixed to prepare a coating solution for forming a first hard coating layer.

### Preparation Example 1-2

100 g of CN9013 (manufacturer: Sartomer, 9-functional, urethane-modified) as a multifunctional acrylate-based compound, 2 g of RS-537 (manufacturer: DIC) as a fluorine-based additive, 2 g of 1907 (manufacturer: Ciba) as a photoinitiator, and 100 g of methyl isobutyl ketone as a solvent were mixed to prepare a coating solution for forming a first hard coating layer.

### Preparation Example 1-3

100 g of trimethylolpropane triacrylate (manufacturer: Cytec, weight average molecular weight: 296 g/mol, acrylate equivalent weight: 99 g/mol) as a multifunctional acrylate-based compound, 2 g of RS-537 (manufacturer: DIC) as a fluorine-based additive, 2 g of 1184 (manufacturer: Ciba) as a photoinitiator, and 100 g of methyl isobutyl ketone as a solvent were mixed to prepare a coating solution for forming a first hard coating layer.

### Preparation Example 1-4

100 g of MF001 (manufacturer: Daiichi Kogyo Seiyaku, 5- to 6-functional, ethylene oxide-modified) as a multifunctional acrylate-based compound, 2 g of RS-537 (manufacturer: DIC) as a fluorine-based additive, 67 g of MEK-AC-4130Y (silica sol, manufacturer: Nissan Chemical, diameter: 50 nm, solid content: 30%) as inorganic particles, 2 g of 1184 (manufacturer: Ciba) as a photoinitiator, and 100 g of methyl isobutyl ketone as a solvent were mixed to prepare a coating solution for forming a first hard coating layer.

### Preparation Example 2-1

50 g of trimethylolpropane triacrylate (manufacturer: Cytec, weight average molecular weight: 296 g/mol, acrylate equivalent weight: 99 g/mol) as a multifunctional acrylate-based compound, 50 g of PS4040 (manufacturer: Miwon, weight average molecular weight: 1300 g/mol, acrylate equivalent weight: 325, 4-functional, ester-modified) as a multifunctional acrylate-based compound, 67 g of MEK-AC-4130Y (silica sol, manufacturer: Nissan Chemical, diameter: 50 nm, solid content: 30%) as inorganic particles, 2 g of 1184 (manufacturer: Ciba) as a photoinitiator, and 100 g of methyl isobutyl ketone as a solvent were mixed to prepare a coating solution for forming a second hard coating layer.

### Preparation Example 2-2

50 g of trimethylolpropane triacrylate (manufacturer: Cytec, weight average molecular weight: 296 g/mol, acrylate equivalent weight: 99 g/mol) as a multifunctional acrylate-based compound, 50 g of M244 (manufacturer: Miwon, weight average molecular weight: 468 g/mol, acrylate equivalent weight: 234 g/mol, 2-functional, epoxy-modified) as a multifunctional acrylate-based compound, 67 g of MEK-AC-4130Y (silica sol, manufacturer: Nissan Chemical, diameter: 50 nm, solid content: 30%) as inorganic particles, 2 g of 1184 (manufacturer: Ciba) as a photoinitiator, and 100 g of methyl isobutyl ketone as a solvent were mixed to prepare a coating solution for forming a second hard coating layer.

### Preparation Example 2-3

50 g of trimethylolpropane triacrylate (manufacturer: Cytec, weight average molecular weight: 296 g/mol, acrylate equivalent weight: 99 g/mol) as a multifunctional acrylate-based compound, 50 g of PS4040 (manufacturer: Miwon, weight average molecular weight: 1300 g/mol, acrylate equivalent weight: 325, 4-functional, ester-modified) as a multifunctional acrylate-based compound, 112.5 g of MEK-AC-2140Z (silica sol, manufacturer: Nissan Chemical, diameter: 12 nm, solid content: 40%) as inorganic particles, 2 g of 1184 (manufacturer: Ciba) as a photoinitiator, and 100 g of methyl isobutyl ketone as a solvent were mixed to prepare a coating solution for forming a second hard coating layer.

### Preparation Example 2-4

50 g of trimethylolpropane triacrylate (manufacturer: Cytec, weight average molecular weight: 296 g/mol, acrylate equivalent weight: 99 g/mol) as a multifunctional acrylate-based compound, 50 g of PS4040 (manufacturer: Miwon, weight average molecular weight: 1300 g/mol, acrylate equivalent weight: 325, 4-functional, ester-modified) as a multifunctional acrylate-based compound, 125 g of MEK-AC-2140Z (silica sol, manufacturer: Nissan Chemical, diameter: 12 nm, solid content: 40%) as inorganic particles, 2 g of 1184 (manufacturer: Ciba) as a photoinitiator, and 100 g of methyl isobutyl ketone as a solvent were mixed to prepare a coating solution for forming a second hard coating layer.

### Preparation Example 2-5

100 g of pentaerythritol triacrylate (manufacturer: Kyoeisha, weight average molecular weight: 298 g/mol, acrylate equivalent weight: 100 g/mol), 125 g of MEK-AC-2140Z (silica sol, manufacturer: Nissan Chemical, diameter: 12 nm, solid content: 40%) as inorganic particles, 2 g of 1184 (manufacturer: Ciba) as a photoinitiator, and 100 g of methyl isobutyl ketone as a solvent were mixed to prepare a coating solution for forming a second hard coating layer.

### Examples and Comparative Examples: Protecting Film for Cover Window of Flexible Display Device

The coating solution for forming a second hard coating layer described in Table 1 below was applied to one surface of a polyethylene terephthalate film, which is a light-transmitting substrate, in a bar coating method, and dried at 60° C. for 2 minutes under an air atmosphere. A second hard coating layer was prepared by photo-curing under a nitrogen atmosphere with a mercury lamp (quantity of light: 100 mJ/cm²).

Thereafter, the coating solution for forming a first hard coating layer described in Table 1 below was applied on the second hard coating layer in a bar coating method, and dried at 60° C. for 2 minutes under an air atmosphere. A first hard coating layer was prepared by photo-curing under a nitrogen atmosphere with a mercury lamp (quantity of light: 200 mJ/cm²) to prepare a protecting film for a cover window.

After curing was completed, the thickness of the first hard coat layer, the second hard coat layer and the polyethylene terephthalate film were measured using a digital micrometer, and the results are shown in Table 1 below.

TABLE 1

| | | | | | | Comp. | Comp. | Comp. | Comp. | Comp. | Comp. |
|---|---|---|---|---|---|---|---|---|---|---|---|
| | | Ex. 1 | Ex. 2 | Ex. 3 | Ex. 4 | Ex. 1 | Ex. 2 | Ex. 3 | Ex. 4 | Ex. 5 | Ex. 6 |
| 1st hard | Coating | Prep. | Prep. | Prep. | Prep. | Prep. | Prep. | Prep. | — | Prep. | Prep. |
| coating | solution | Ex. 1-1 | Ex. 1-1 | Ex. 1-2 | Ex. 1-1 | Ex. 1-3 | Ex. 1-4 | Ex. 1-1 | | Ex. 1-1 | Ex. 1-1 |
| layer | Thickness | 2 | 1.5 | 3 | 2 | 5 | 2 | 5 | — | 2 | 2 |
| | (μm) | | | | | | | | | | |
| 2nd hard | Coating | Prep. | Prep. | Prep. | Prep. | — | Prep. | Prep. | Prep. | Prep. | Prep. |
| coating | solution | Ex. 2-1 | Ex. 2-2 | Ex. 2-2 | Ex. 2-3 | | Ex. 2-2 | Ex. 2-2 | Ex. 2-1 | Ex. 2-4 | Ex. 2-5 |
| layer | Thickness | 5 | 6 | 10 | 5 | — | 5 | 3 | 5 | 5 | 5 |
| | (μm) | | | | | | | | | | |

| | | | | | | | | | | |
|---|---|---|---|---|---|---|---|---|---|---|
| Thickness of light- | 75 | 100 | 75 | 75 | 75 | 75 | 75 | 75 | 75 | 75 |
| transmitting substrate | | | | | | | | | | |
| (μm) | | | | | | | | | | |

### Experimental Examples: Measurement of Physical Properties of Protecting Film for Cover Window of Flexible Display Device

### Experimental Example 1: Pencil Hardness

For the first hard coating layer of each protecting film of Examples and Comparative Examples, a pencil was reciprocated three times at 45 degrees under a load of 750 g using a pencil hardness measuring device according to JIS K5400-5-4, and then the maximum hardness without scratches was confirmed.

### Experimental Example 2: Bending Resistance Test

According to JIS K5600-5-1, each protecting film of Examples and Comparative Examples was wound around cylindrical mandrels of various diameters, and then the minimum diameter at which cracks with a length of 3 mm or more did not occur was measured.

### Experimental Example 3: Bending Durability Test

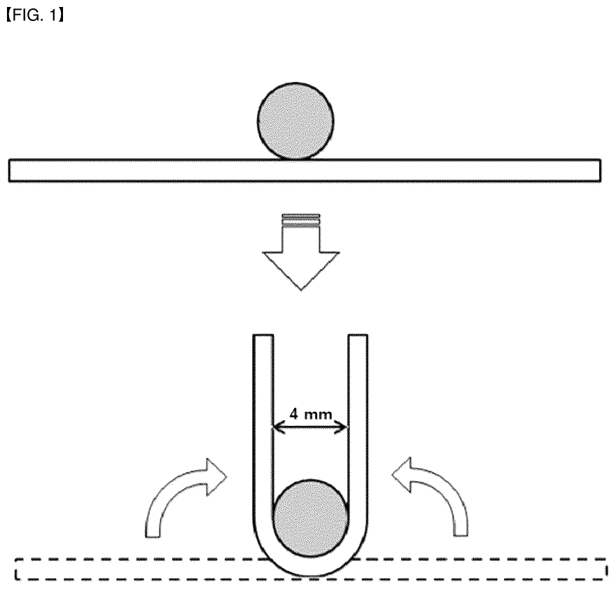

FIG. 1 schematically shows a method for testing bending durability and bending stability of a protecting film according to an embodiment of the present disclosure.

Each protecting film of Examples and Comparative Examples was laser-cut to a size of 80×140 mm to minimize microcracks in the edge. The laser-cut film was placed on a measuring device, and folded and unfolded at 90 degrees with respect to a bottom surface 100,000 times in a continuous operation at room temperature (at a rate of once per 1.5 seconds) such that a gap between folded parts (inner curvature diameter) was 4 mm with a light-transmitting substrate inside.

After repeating 10,000 times, the film was removed and observed whether cracks with a length of 3 mm or more occurred. When cracks did not occur, bending 10,000 times and observing whether cracks occurred was repeated again to measure the maximum number of repetitions without cracks. When cracks did not occur until repeated 100,000 times, it was evaluated as good, and when cracks occurred, it was evaluated as bad.

### Experimental Example 4: Scratch Resistance Test

For the hard coating layer formed on the front surface of each protecting film of Examples and Comparative Examples, a steel wool (#0000) with a load of 500 gf was reciprocated 100 times at 30 rpm, and the surface of the hard coating film was measured. When one or less scratch of 1 cm or less was observed with the naked eye, it was evaluated as good, and when more than one scratch was observed, it was evaluated as bad.

### Experimental Example 5: Transmittance and Haze

For each protecting film of Examples and Comparative Examples, the transmittance and the haze were measured using a spectrophotometer (device name: COH-400).

The measurement results of physical properties for Examples and Comparative Examples are shown in Table 2 below.

TABLE 2

| | | | | | Comp. | Comp. | Comp. | Comp. | Comp. | Comp. |
|---|---|---|---|---|---|---|---|---|---|---|
| | Ex. 1 | Ex. 2 | Ex. 3 | Ex. 4 | Ex. 1 | Ex. 2 | Ex. 3 | Ex. 4 | Ex. 5 | Ex. 6 |
| Pencil hardness | 2H | 2H | 2H | 2H | 2H | 2H | 2H | H | 2H | 3H |
| Bending | 6 | 5 | 6 | 8 | 12 | 6 | 10 | 4 | 10 | 16 |
| resistance (mm) | | | | | | | | | | |
| Bending durability | Good | Good | Good | Good | Bad | Good | Bad | Good | Bad | Bad |
| Scratch resistance | Good | Good | Good | Good | Good | Bad | Good | Bad | Good | Good |
| Transmittance (%) | 92.0 | 92.1 | 92.0 | 92.1 | 92.2 | 92.0 | 92.1 | 92.2 | 92.1 | 92.0 |
| Haze (%) | 0.3 | 0.4 | 0.3 | 0.3 | 0.3 | 0.3 | 0.4 | 0.3 | 0.3 | 0.3 |

As shown in Table 2 above, the protecting films for a cover window of a flexible display device of Examples satisfied sufficient flexibility while exhibiting high hardness, and had excellent scratch resistance and optical properties such as transmittance and haze. In particular, there was almost no damage to the film even by repetitive bending or folding operations. Accordingly, it was confirmed that they could be usefully applied to a bendable, flexible, rollable, or foldable mobile device, a display device, or the like.

In contrast, the protecting films of Comparative Examples exhibited relatively low scratch resistance, or did not exhibit bending durability enough to be used as a protecting film of a flexible display device, unlike in Examples.

Specifically, it was confirmed that Comparative Example 1 including only the first hard coating layer, Comparative Example 3 in which the first hard coating layer is thicker than the second hard coating layer, and Comparative Examples 5 and 6 containing more than 45 parts by weight of nano silica in the second hard coating layer based on 100 parts by weight of the binder resin had bending durability insufficient for a protecting film of a flexible display device.

On the other hand, it was confirmed that Comparative Example 2 containing more than 3 parts by weight of nano silica in the first hard coating layer based on 100 parts by weight of the binder resin and Comparative Example 4 including only the second hard coating layer had low scratch resistance.

1. A protecting film for a cover window of a flexible display device comprising
a first hard coating layer containing a binder resin and 3 parts by weight or less of inorganic particles based on 100 parts by weight of the binder resin;
a second hard coating layer containing a binder resin and 10 to 45 parts by weight of inorganic particles based on 100 parts by weight of the binder resin; and
a light-transmitting substrate are sequentially laminated,
wherein a thickness ratio of the first hard coating layer and the second hard coating layer is 10:90 to 40:60.

2. The protecting film for a cover window of a flexible display device of claim 1,
wherein cracks do not occur when both sides of the protecting film for a cover window are folded and unfolded at 90 degrees with respect to a bottom surface 100,000 times at room temperature with a 4 mm gap in the middle of the protecting film for a cover window.

3. The protecting film for a cover window of a flexible display device of claim 1,
wherein the first hard coating layer has a pencil hardness of at least H under a load of 750 g.

4. The protecting film for a cover window of a flexible display device of claim 1,
wherein a surface of the first hard coating layer has a water contact angle of at least 105°.

5. The protecting film for a cover window of a flexible display device of claim 1,
wherein the protecting film for a cover window has a transmittance with respect to light having a wavelength of 550 nm of 90.0% or more, and a haze of 1.0% or less.

6. The protecting film for a cover window of a flexible display device of claim 1,
wherein a thickness of the first hard coating layer is 1 μm to 10 μm.

7. The protecting film for a cover window of a flexible display device of claim 1,
wherein a thickness of the second hard coating layer is 1 μm to 10 μm.

8. The protecting film for a cover window of a flexible display device of claim 1,
wherein a total thickness of the first hard coating layer and the second hard coating layer is 2 μm to 17 μm.

9. The protecting film for a cover window of a flexible display device of claim 1,
wherein the binder resin included in each of the first hard coating layer and the second hard coating layer contains a multifunctional (meth)acrylate-based compound.

10. The protecting film for a cover window of a flexible display device of claim 9,
wherein the first hard coating layer and the second hard coating layer each independently contain 50 parts by weight or more of the multifunctional (meth)acrylate-based compound based on 100 parts by weight of the binder resin.

11. The protecting film for a cover window of a flexible display device of claim 9,
wherein the multifunctional (meth)acrylate-based compound is modified with at least one selected from the group consisting of ethylene oxide, propylene oxide, urethane, caprolactone, epoxy, and ester.

12. The protecting film for a cover window of a flexible display device of claim 1,
wherein the first hard coating layer further contains at least one additive selected from the group consisting of a fluorine-based additive, a silicone-based additive, and a fluorine-silicone-based additive.

13. The protecting film for a cover window of a flexible display device of claim 1,
wherein the light-transmitting substrate comprises at least one selected from the group consisting of polyimide (PI), polyimideamide, polyetherimide (PEI), polyethyleneterephtalate (PET), polyethylenenaphthalate (PEN), polyetheretherketon (PEEK), cyclic olefin polymer (COP), polyacrylate (PAC), polymethylmethacrylate (PMMA), and triacetylcellulose (TAC).

14. The protecting film for a cover window of a flexible display device of claim 1,
wherein a total thickness of the first hard coating layer, the second hard coating layer and the light-transmitting substrate is 40 μm to 150 μm.

15. A cover window of a flexible display device comprising the protecting film for a cover window of a flexible display device of claim 1.

16. The cover window of a flexible display device of claim 15,
further comprising a glass cover or a plastic film cover formed on one surface of the protecting film for a cover window and having a thickness of 20 μm to 180 μm.

17. A display device comprising the cover window of a flexible display device of claim 15.
